(19) United States
(12) Patent Application Publication
(10) Pub. No.: US 2006/0282785 A1
(43) Pub. Date: Dec. 14, 2006

(54) System and method of displaying content in display windows

(75) Inventors: Mary Catherine McCarthy, San Antonio, TX (US); Scott Alan Pettit, San Antonio, TX (US); Roland Noll, San Antonio, TX (US); Christopher Alan Lee, San Antonio, TX (US); Norman Ross Cox III, Kyle, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/148,967

(22) Filed: Jun. 9, 2005

(51) Int. Cl. G06F 9/00

(52) U.S. Cl. 715/760

(57) ABSTRACT

A display device comprising a first window displaying a first content item and a second window displaying a second content item is disclosed. The first content item is displayed through use of a first communication path having a first bandwidth. The second content item is displayed through use of a second communication path having a second bandwidth that is less than the first bandwidth.

### FIELD OF THE DISCLOSURE

The present disclosure relates to a system and method of displaying content in different display windows.

### BACKGROUND

### BRIEF DESCRIPTION OF THE DRAWINGS

FIG. 1 is a block diagram that illustrates an embodiment of a system including a display device;

FIG. 2 is a general diagram that illustrates a display of the display device; and

FIG. 3 is a flow chart that illustrates a method of displaying content on the display device.

### DETAILED DESCRIPTION OF THE DRAWINGS

A display device including a first window displaying a first content item and a second window displaying a second content item is disclosed. The first content item is displayed through use of a first communication path having a first bandwidth. The second content item is displayed through use of a second communication path having a second bandwidth that is less than the first bandwidth.

A method of displaying content on a display device is disclosed. The method includes displaying a first content stream at a first window and displaying a second content stream at a second window. The first content stream is displayed via a first communication path having a first bandwidth and the second content stream displayed via a second communication path having a second bandwidth that is less than the first bandwidth.

A system is disclosed that includes a first interface to receive signals from a remote control device, a second interface to a display device, and a controller responsive to the first interface and providing control signals to the second interface to modify the content displayed on the display device in response to user commands from the remote control device. The display device is to display a first window displaying a first content item where the first content item is displayed through use of a first communication path having a first bandwidth and to display a second window displaying a second content item, where the second content item is displayed through use of a second communication path having a second bandwidth that is less than the first bandwidth.

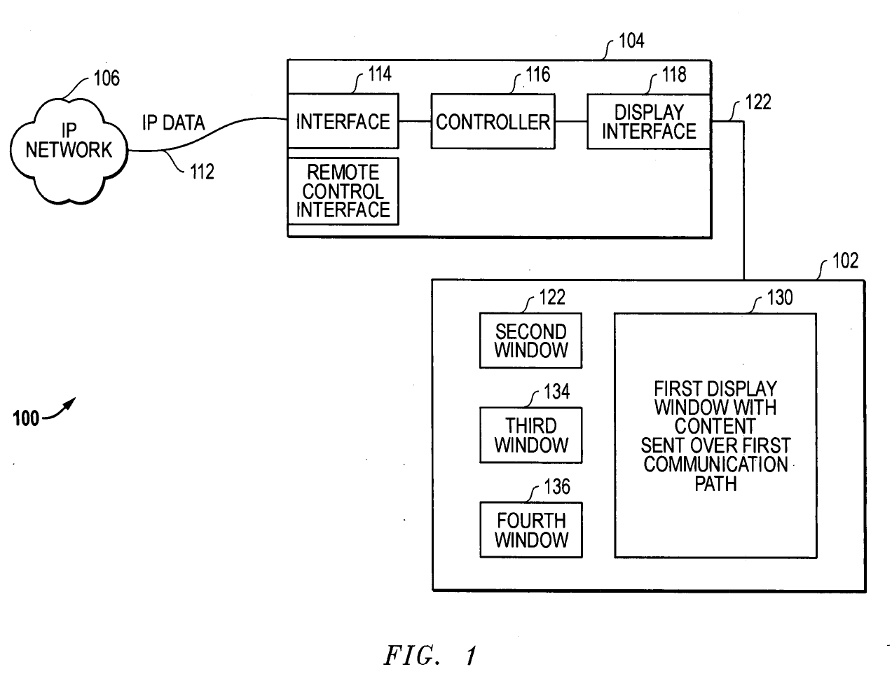

Referring to FIG. 1, a particular embodiment of a system 100 is shown. The system 100 includes a communication system 104, such as a set top box coupled to a display device 102. The communication system 104 is also coupled via an IP data interface 114 to receive and transmit IP data 112 with respect to an external IP network 106. The communication system 104 also includes a controller 116 and a display interface 118. The display interface 118 is coupled via communication paths 122 that may communicate multiple data streams at different communication rates with different bandwidth capabilities to the display device 102 for display.

The communication system 104 may be a set top box that is coupled to a television. The set top box is controlled by a remote control device 150 using a wireless interface 140 and a transceiver 142. The display device 102 includes a first display window 130, a second display window 132, a third display window 134, and a fourth display window 136. While four representative display windows are shown, it should be understood that the display device 102 may include a plurality of windows that may form a display mosaic and may be suitable for use as a video guide and/or for providing a video display for viewing a variety of content.

The first display window 130 may display content that is sent over a first communication data path between the communication system 104 and the display device 102. The second window 132 may display data that has been communicated over a second communication path to the display device 102 from the communication system 104. Similarly, the third window 134 and the fourth window 136 may display content communicated over a third and a fourth communication path to the display device 102 from the communication system 104.

In a particular embodiment, the first communication path associated with the first display window 130 has a first bandwidth and the second communication path associated with the second display window 132 has a second bandwidth. The second bandwidth is less than the first bandwidth associated with the first window 130. The content items that may be displayed in the first display window 130 include content items that may consume larger bandwidth since the first communication path provides bandwidth to the first display window 130 that is greater than the second communication path that supports display of content at the second display window 132.

In an exemplary embodiment, a first content item to be displayed in the first display window 130 is related to a common broadcast program with respect to a second item content item to be displayed within the second display window 132. In another embodiment, the first content item provides a first view of an event, such as a sporting event, and the second content item provides a second view of the event. As a further example, the first content item and the second content item may provide different views from different vantage points associated with various camera angles of a sporting event being broadcast. As a particular example, the first bandwidth of the first communication path may be about 2 megabits per second and the second bandwidth of the second communication path may be less than 300 kilobits per second. In a specific example, the third display window 134 may provide yet a further view of a common broadcast program as the second window 132 and the first display window 130. Optionally, the fourth display window 136 may display a program that is different than the common broadcast event, such as a program other than the sporting event displayed in the first, second and third windows, respectively. Thus, with the display device 102 shown, different content data streams with different bandwidth requirements and related to a common broadcaster to different programs may be displayed in different windows of the display device based on user selection.

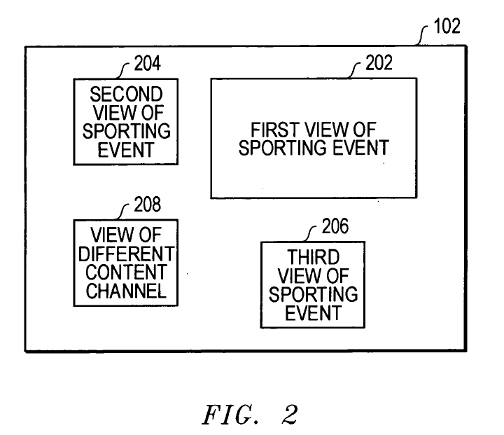

Referring to FIG. 2, a particular embodiment of the display device 102 is shown. The display device includes a first view 202, a second view 204, a third view 206, and a fourth view 208. The first view 202 in the illustrated embodiment is a view of a sporting event. The second view 204 is a different view of the common sporting event shown in the first view, and the third view 206 also provides a view of the sporting event but from yet a third vantage point. In the illustrative embodiment, the fourth window 208 shows a display of a different content item or a completely different broadcast channel. Thus, with the display device and multiple windows as shown where each window may have a common or a different bandwidth capability, a variety of views of a common event such as a sporting event may be shown to provide an enhanced user experience.

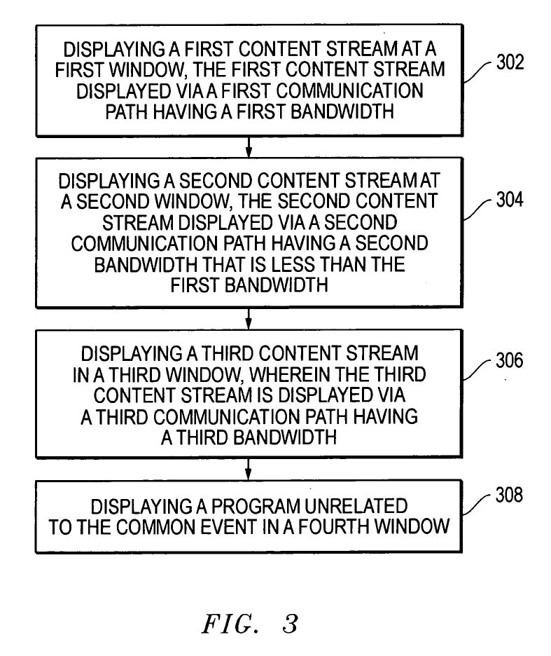

Referring to FIG. 3, a method of displaying content on a display device is shown. The method includes displaying a first content data stream at a first window where the first content data stream is displayed via a first communication path having a first bandwidth, as shown at 302. The method further includes displaying a second content data stream at a second window where the second content data stream is displayed via a second communication path having a second bandwidth that is less than the first bandwidth, as shown at 304. The method further includes a step of displaying a third content data stream in a third window where the third content data stream is displayed via a third communication path having a third bandwidth, as shown at 306, and displaying a program in a fourth window where the program is unrelated to a common event that is displayed in the first, second and third windows, as shown at 308.

In a particular embodiment, the first content stream provides a first view of a sporting event, the second content stream provides a second view of the sporting event, and the different first and second views provide different vantage points or camera angles with respect to viewing of the sporting event. In another embodiment, a plurality of different views display different content streams but with a common theme, such as a variety of different news content channels or other grouped broadcast content items. Also, in a particular example, one of the windows may be displayed in a full screen upon user selection, such that the selected window may provide a full display after multiple smaller windows are presented in a video guide mosaic format for user selection of a particular program. Also, audio for one of the channels in one of the windows may be played and audio for another related channel may be selected and then played upon user selection. Thus, the display device may provide a video guide function offering a display of a plurality of different channels and upon user selection, one of the plurality of channels and may be displayed in a full screen display or a larger display window and the audio content for the corresponding selected channel may then be played for the user.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a first window displaying a first content item, wherein the first content item is displayed through use of a first communication path having a first bandwidth; and
a second window displaying a second content item, wherein the second content item is displayed through use of a second communication path having a second bandwidth that is less than the first bandwidth.

2. The display device of claim 1, wherein the first content item and the second content item are related to a common broadcast program.

3. The display device of claim 2, wherein the first content item provides a first view of an event and the second content item provides a second view of the event.

4. The display device of claim 3, wherein the event is a sports event and wherein the first view and the second view provide different vantage points with respect to viewing the sports event.

5. The display device of claim 1, further comprising a third window displaying a third content item, wherein the third content item is displayed through use of a third communication path having a third bandwidth.

6. The display device of claim 1, wherein the first bandwidth is 2 megabits per second and the second bandwidth is less than 300 kilobits per second.

7. The display device of claim 5, wherein the first window, the second window, and the third window provide different views of a common event.

8. The display device of claim 7, wherein the different views are provided by different camera locations of the common event.

9. The display device of claim 8, further comprising a fourth window that displays a different program that is unrelated to the common event.

10. The display device of claim 1 wherein the first content stream is a first data stream and the second content stream is a second data stream.

11. A method of displaying content on a display device, the method comprising:
displaying a first content stream at a first window, the first content stream displayed via a first communication path having a first bandwidth; and
displaying a second content stream at a second window, the second content stream displayed via a second communication path having a second bandwidth that is less than the first bandwidth.

12. The method of claim 11, wherein the first content stream and the second content stream are related to a common broadcast program.

13. The method of claim 12, wherein the first content stream provides a first view of an event and the second content stream provides a second view of the event.

14. The method of claim 13, wherein the event is a sports event and wherein the first view and the second view provide different vantage points with respect to viewing the sports event.

15. The method of claim 1 further comprising displaying a third content stream in a third window, wherein the third content stream is displayed via a third communication path having a third bandwidth.

16. The method of claim 15, wherein the first window, the second window, and the third window provide different views of a common event.

17. The method of claim 16, wherein the different views are provided by different camera locations of the common event.

18. The method of claim 17, further comprising displaying a program unrelated to the common event in a fourth window.

19. The method of claim 11, wherein a plurality of related channels are presented on a single screen.

20. The method of claim 19, wherein the plurality of related channels provide news content.

21. The method of claim 19, wherein the plurality of related channels provide sports content.

22. The method of claim 11, wherein a plurality of windows are displayed, including the first and second window, and wherein the plurality of windows display content based on a particular user preference.

23. The method of claim 11, wherein after one of the first and second windows is selected, the selected window is displayed in a full screen, such that the first window and the second window provide a video guide function for user selection of a program.

24. The method of claim 11, wherein an audio for one of the related channels is played and wherein audio for another of the related channels may be selected and played upon user selection.

25. A system comprising:
a first interface to receive signals from a remote control device;
a second interface to a display device, the display device to display a first window displaying a first content item, wherein the first content item is displayed through use of a first communication path having a first bandwidth; and
a second window displaying a second content item, wherein the second content item is displayed through use of a second communication path having a second bandwidth that is less than the first bandwidth; and
a controller responsive to the first interface and providing control signals to the second interface to modify the content displayed on the display device in response to user commands from the remote control device.
